(19) United States
(12) Patent Application Publication
(10) Pub. No.: US 2021/0396233 A1
(43) Pub. Date: Dec. 23, 2021

(54) GLANDED PUMP WITH RING CAPACITOR

(71) Applicant: NIDEC GPM GmbH, Auengrund OT Merbelsrod (DE)

(72) Inventor: Franz PAWELLEK, Lautertal (DE)

(21) Appl. No.: 17/279,132

(22) PCT Filed: Sep. 25, 2019
(86) PCT No.: PCT/EP2019/075824

§ 371 Date: Mar. 24, 2021

(30) Foreign Application Priority Data
Sep. 25, 2018 (DE) 10 2018 123 565.8

(51) Int. Cl. F04D 13/08; F04D 13/06; F04D 29/12; F04D 29/52

(52) U.S. Cl. CPC F04D 13/086; F04D 29/52; F04D 29/12; F04D 13/0653

(57) ABSTRACT

A glanded pump to pump a pumped medium includes a motor to drive a pump shaft of the glanded pump about a longitudinal axis, a controller connected to the motor to control the motor, a pump housing to contain the pumped medium and in which an impeller is provided, and a sealing flange that seals off the pump housing from the motor. The controller is connected to the sealing flange on a side remote from the impeller, and the controller includes a printed circuit board and a ring capacitor thereon, the ring capacitor extending in the longitudinal direction between the printed circuit board and the sealing flange and being in direct contact with the sealing flange in order to provide a thermally conductive contact.

### CROSS REFERENCE TO RELATED APPLICATIONS

This application claims the benefit of priority to German Patent Application No. 10 2018 123 565.8, filed on Sep. 25, 2018, and is a National Stage Application of PCT Application No. PCT/EP2019/075824, filed on Sep. 25, 2019. The entire contents of each of the above applications are hereby incorporated herein by reference.

### 1. FIELD OF THE INVENTION

The present invention relates to a glanded pump, and more specifically, to a glanded pump used in pumping a pumping medium.

### 2. BACKGROUND

Glanded pumps require commutation electronics, which can be arranged between the stator and the sealing flange. The available installation space is very tight. The cup-shaped capacitors commonly used today are the largest components on the circuit board and generally mean that the overall length of the pump housing has to be increased to accommodate the capacitors.

US 2002/0171301 A1 discloses a single-phase motor for submersible pumps, which has a ring capacitor arranged between a pump head and a stator winding package.

A submersible pump is known from U.S. Pat. No. 6,359,353 B1, which shows a ring capacitor arranged in a stator chamber. The ring capacitor is arranged at a distance from the stator and encloses a rotor chamber. The electric motor is a capacitor motor. It uses the energy of the capacitor during the starting process. The capacitor creates a phase shift to generate additional torque.

### SUMMARY

Example embodiments of the present disclosure provide glanded pumps each with a compact dimension.

A glanded pump to pump a pumped medium according to an example embodiment of the present disclosure includes a motor to drive a pump shaft of the glanded pump about a longitudinal axis, a controller connected to the motor to control the motor, a pump housing to contain the pumped medium, in which an impeller is provided, and a sealing flange which seals off the pump housing from the motor. The controller is connected to the sealing flange on a side remote from the impeller. The controller includes an annular printed circuit board and a ring capacitor thereon. The ring capacitor extends in the longitudinal direction between the printed circuit board and the sealing flange and concentrically with respect to both and is in direct contact with the sealing flange in order to provide a thermally conductive contact.

The ring capacitor is not only arranged to save space, it also transfers the heat generated in the controller to the sealing flange so that it can be dissipated.

The ring capacitor preferably rests with a first end surface on the printed circuit board and with a second end surface opposite the first end surface on the side of the sealing flange remote from the impeller.

The sealing flange is preferably cooled on a side close to the impeller by a flowing pumped medium.

In an example embodiment, the sealing flange is made from a material with increased thermal conductivity, for example, aluminum.

It is advantageous if the motor is an electronically commutated electric motor including a stator and a rotor, the stator being located on a side of the sealing flange remote from the impeller. In this case, the rotor is connected to the pump shaft in a rotationally fixed manner.

It is preferred that the glanded pump is an external rotor pump.

Preferably, the pump shaft passes through the sealing flange. It is advantageous if a mechanical seal is between the pump shaft and the sealing flange.

The ring capacitor may be attached to the printed circuit board by through-hole technology and soldering.

In an advantageous example embodiment, a height of the ring capacitor in a longitudinal direction is several times smaller than a width of the ring.

It is advantageous if the ring capacitor is glued to the sealing flange.

Furthermore, a coolant pump for motor vehicles is provided, which has a glanded pump described above.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 depicts an example embodiment of a glanded pump 1 according to an example embodiment of the present disclosure.

### DETAILED DESCRIPTION

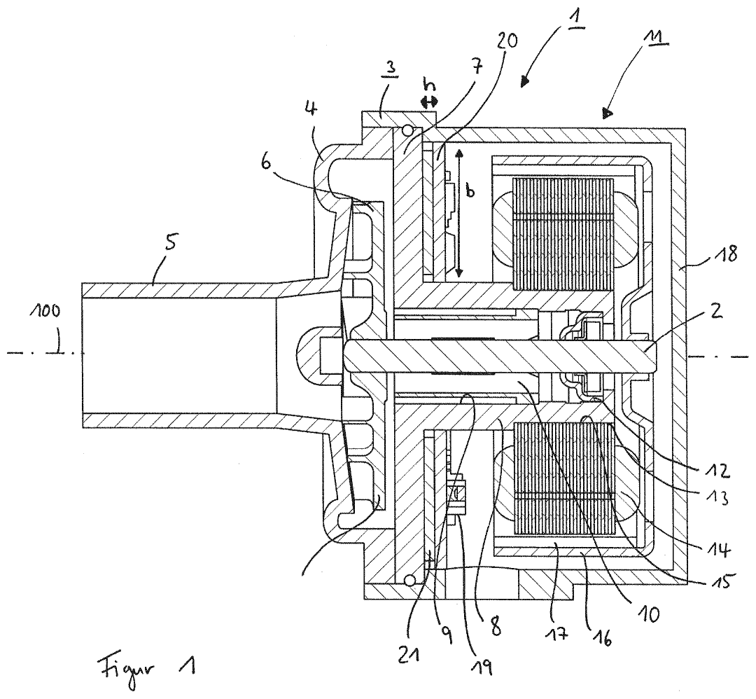

FIG. 1 shows a longitudinal section through a glanded pump 1 along a longitudinal axis 100 of a pump shaft 2. The pump 1 is designed as an external rotor. The pump 1 is enclosed by a housing 3, the housing 3 having a pump casing 4 with suction port 5 through which the pumped medium is moved. An impeller 6, which is seated on the pump shaft 2 in a rotationally fixed manner, is arranged in the pump housing 4. A sealing flange 7 is inserted in the pump housing 4, which has a dome-like elevation 8 with a recess passing through it centrally for the pump shaft 2 to pass through. The dome-like elevation 8 points away from the impeller 6 in the installed state. The recess 9 surrounds a bearing 10 in which the pump shaft 2 is rotatably mounted. The sealing flange 7 serves to seal the pump housing 4 carrying the pumped medium from a motor 11 which drives the pump shaft 2. For this purpose, a mechanical seal 12 is inserted in the recess 9 at the end of the recess 9 remote from the impeller, concentrically surrounding the pump shaft 2 and providing a seal between the sealing flange 7 and the pump shaft 2 within the recess 9. The bearing 10 is thus immersed in fluid, providing improved efficiency. A seat 13 for a stator 14 is provided on the outside of the elevation. The stator 14 has a centrally penetrating bore 15 through which the sealing flange 7 passes, so that the stator 14 is firmly seated on the elevation 8 of the sealing flange 7 concentrically to the longitudinal axis 100. The mechanical seal 12 is located at the level of the stator 14. The stator 14 is surrounded on the outside by a pot-shaped rotor 16. The rotor 16 is seated on the pump shaft 2 in a rotationally fixed manner. It has permanent magnets 17 lying on the inside of the shell. The rotor 16 is completely surrounded by a motor cover 18, which is connected to the pump housing 4 and the sealing flange 7 lying between them in the axial direction.

For controlling the motor 11, the stator 14 is connected to a controller 19, which is arranged inside the housing 3 lying between the stator 14 and the sealing flange 7, viewed in longitudinal direction. The controller 19 has a printed circuit board 20 to which a ring capacitor 21 is attached. The fastening is preferably carried out using the so-called push-through technique and by soldering. The ring capacitor 21 rests with a first end surface on the printed circuit board 20. The ring capacitor 21 surrounds the elevation of the sealing flange 8 and is arranged concentrically to this and to the longitudinal axis 100. The ring capacitor 21 directly abuts the outer surface of the sealing flange 7 with a second end surface opposite the first end surface. The ring capacitor 21 has an inner radius and an outer radius. Whereby the ring width b represents the difference between the two radii. In the longitudinal direction, the ring capacitor extends over a height h. The height of the capacitor is many times smaller than the ring width. The height of the capacitor h is between 3 mm and 15 mm.

The ring capacitor 21 enables a flat, compact design of the printed circuit board 20. As a result of the large contact surface to the printed circuit board 20, there is a very good vibration-resistant connection of the ring capacitor 21 to the controller 19. Since the ring capacitor 21 is in direct contact with the sealing flange, it can absorb heat losses from the controller 19 as a result of the large contact surface and transfer them to the sealing flange 7. Preferably, the ring capacitor 21 is bonded to the sealing flange 7. The sealing flange 7 is preferably made of aluminum and has good thermal conductivity, so that the heat can be transferred from the ring capacitor 21 to the pumped medium via the sealing flange 7.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-12. (canceled)

13. A glanded pump to pump a pumping medium, the glanded pump comprising:
a motor to drive a pump shaft of the glanded pump about a longitudinal axis extending in a longitudinal direction;
a controller connected to the motor to control the motor;
a pump housing to contain the pumped medium, in which an impeller is provided; and
a sealing flange that seals off the pump housing from the motor; wherein
the controller is connected to the sealing flange on a side of the sealing flange positioned away from the impeller, the controller including a printed circuit board and an ring capacitor thereon;
the ring capacitor extends in the longitudinal direction between the printed circuit board and the sealing flange and is concentric to both the printed circuit board and the sealing flange; and
the ring capacitor is in direct contact with the sealing flange to provide a thermally conductive contact.

14. The glanded pump according to claim 13, wherein the sealing flange is cooled on a side adjacent to the impeller by a flowing pumped medium.

15. The glanded pump according to claim 13, wherein the sealing flange is made of a material with increased thermal conductivity compared to other portions of the glanded pump.

16. The glanded pump according to claim 15, wherein the sealing flange is made of aluminum.

17. The glanded pump according to claim 13, wherein the motor is an electronically commutated electric motor including a stator and a rotor, the stator being seated on a side of the sealing flange spaced away from the impeller.

18. The glanded pump according to claim 17, wherein the glanded pump is an external rotor pump.

19. The glanded pump according to claim 13, wherein the pump shaft passes through the sealing flange and a mechanical seal is between the pump shaft and the sealing flange.

20. The glanded pump according to claim 13, wherein the ring capacitor is fixed on the printed circuit board by through-holes and soldering.

21. The glanded pump according to claim 13, wherein the ring capacitor includes a first end surface against the printed circuit board and a second end surface, opposite the first end surface, which is against a side of the sealing flange spaced away from the impeller.

22. The glanded pump according to claim 13, wherein a total height of the ring capacitor in the longitudinal direction is smaller than a width of the ring.

23. The glanded pump according to claim 13, wherein the ring capacitor is glued onto the sealing flange.

24. A coolant pump for a motor vehicle comprising the glanded pump according to claim 13.
